(19) United States
(12) Patent Application Publication
(10) Pub. No.: US 2014/0251769 A1
(43) Pub. Date: Sep. 11, 2014

(54) No Trip At Off Circuit Breakers And Methods Of Operating Same

(71) Applicants: Xinhua Chen, Atlanta, GA (US); Jorg Sizemore, Duluth, GA (US); Kevin R. Warne, Dawsonville, GA (US)

(72) Inventors: Xinhua Chen, Atlanta, GA (US); Jorg Sizemore, Duluth, GA (US); Kevin R. Warne, Dawsonville, GA (US)

(73) Assignee: Siemens Aktiengesellschaft, Munchen (DE)

(21) Appl. No.: 14/352,512

(22) PCT Filed: Oct. 18, 2011
(86) PCT No.: PCT/US2011/056653

§ 371 Date: Apr. 28, 2014

(51) Int. Cl. H01H 9/00

(52) U.S. Cl. CPC H01H 9/00
USPC 200/43.16

(57) ABSTRACT

Embodiments provide a circuit breaker exhibiting no trip at OFF functionality. The circuit breaker includes a blocking subassembly that effectively blocks tripping of a trip bar when the circuit breaker is in the OFF configuration. The blocking subassembly may include a translating plunger cooperating with a rotatable trip bar block. The trip bar block is aligned with the trip bar in the OFF configuration. Methods of operating the circuit breaker are provided, as are other aspects.

### FIELD OF THE INVENTION

The present invention relates generally to circuit breakers for interrupting current from an electrical power supply, and more particularly to trip mechanisms and methods for circuit breakers.

### BACKGROUND OF THE INVENTION

Electronic circuit breakers are used in certain electrical systems for protecting an electrical circuit coupled to an electrical power supply. Such circuit breakers include ON, OFF and TRIP configurations. Prior art circuit breakers may be tripped even when in the OFF configuration, such as by a test function Universal Voltage Regulator (UVR), a shunt, or by pulling the circuit breaker out of its plug-in socket. For various reasons it is undesirable to have such OFF configuration trips. For example, it may lead to an undesired reaction in the system such as activation of an integrated alarm switch. Moreover, such unwanted trips may require a follow up action.

Accordingly, there is a need for a circuit breaker that cannot trip in the OFF configuration.

### SUMMARY OF THE INVENTION

In a first aspect, a circuit breaker is provided. The circuit breaker includes a blocking subassembly adapted to block tripping of the circuit breaker in the OFF configuration.

According to another aspect, a circuit breaker is provided. The circuit breaker includes a trip bar adapted to rotate in response to a tripping event, and a blocking subassembly adapted to block tripping of the trip bar when the circuit breaker is in an OFF configuration.

In yet another aspect, a circuit breaker is provided. The circuit breaker includes a frame, a handle arm moveable relative to the frame, a trip bar adapted to rotate in response to a tripping event, and a blocking subassembly adapted to block motion of the trip bar when the circuit breaker is in an OFF configuration, the blocking subassembly having a plunger translatable relative to the frame in a guide, the plunger including a first end adapted to engage the handle arm and a second end, and a rotatable trip bar block having a first portion and a second portion, the first portion adapted to engage the second end of the plunger, and the second portion adapted to contact the trip bar to prevent tripping in the OFF configuration.

According to another aspect, a method of operating a circuit breaker is provided. The method includes providing a trip bar, and blocking motion of the trip bar with a blocking subassembly when the circuit breaker is in an OFF configuration.

Still other aspects, features, and advantages of the present invention may be readily apparent from the following detailed description by illustrating a number of example embodiments and implementations, including the best mode contemplated for carrying out the present invention. The present invention may also be capable of other and different embodiments, and its several details may be modified in various respects, all without departing from the spirit and scope of the present invention. Accordingly, the drawings and descriptions are to be regarded as illustrative in nature, and not as restrictive. The invention is to cover all modifications, equivalents, and alternatives falling within the spirit and scope of the invention.

### BRIEF DESCRIPTION OF DRAWINGS

FIG. 1 is a side view of an embodiment of a circuit breaker shown in an ON configuration.

FIG. 2 is a side view of an embodiment of a circuit breaker shown in a just prior to OFF configuration.

FIG. 3 is a side view of an embodiment of a circuit breaker shown in an OFF configuration.

FIG. 4 is a side view of an embodiment of a circuit breaker shown in a NO TRIP AT OFF configuration with the trip bar blocked.

FIG. 5 is a side view of an embodiment of a circuit breaker shown in a TRIP configuration.

FIG. 6 is a side view of an embodiment of a circuit breaker shown in a RESET configuration.

FIG. 7A is an isometric view of an embodiment of a circuit breaker having a no trip at OFF functionality.

FIG. 7B is a cross sectioned side view of an embodiment of a circuit breaker illustrating other circuit breaker components.

FIG. 8 is an isometric side view of an embodiment of a blocking subassembly mounted to a frame.

FIG. 9 is an isometric rear detached view of an embodiment of a blocking subassembly illustrating the components thereof.

FIG. 10 is an isometric view of an embodiment of a plunger of a blocking subassembly.

FIG. 11 is an isometric view of an embodiment of a plunger holder of a blocking subassembly.

FIG. 12 is a front view of an embodiment of a spring of a plunger subassembly.

FIG. 13 is an isometric view of an embodiment of a trip bar.

FIG. 14 is an isometric view of an embodiment of a trip bar block of a blocking subassembly.

FIG. 15 is an isometric view of an embodiment of a biasing spring of a blocking subassembly.

FIG. 16 is a partially cross-sectioned front view of an embodiment of a plunger subassembly including a plunger, plunger holder, and spring.

FIG. 17 is a flowchart illustrating a method of operating a circuit breaker according to embodiments.

### DETAILED DESCRIPTION

In view of the foregoing difficulties, and, in particular, the OFF configuration tripping exhibited by conventional circuit breakers, a no trip at OFF circuit breaker is provided. In particular, the circuit breaker includes functionality that prevents the circuit breaker from tripping when in the OFF configuration. According to embodiments, a blocking subassembly is provided that is adapted to block tripping of the circuit breaker in the OFF configuration by interfering with a motion of a trip bar of the circuit breaker. In some embodiments, the blocking subassembly includes a trip bar block. The trip bar block may interface with a spring-biased plunger. The trip bar block is moved into a blocking orientation as a handle arm of the circuit breaker is moved to the OFF configuration. The blocking orientation may include alignment of a trip bar block with an extending portion of the trip bar in the OFF configuration. This effectively blocks the circuit breaker from tripping in the OFF configuration due to one of the causes listed above.

In another broad aspect, a method of operating a circuit breaker is provided. The method causes blocking of a trip bar when the circuit breaker is in the OFF configuration thereby preventing tripping in the OFF configuration.

Advantageously, the present invention solves the problem of the prior art, i.e., tripping when the circuit breaker is in the OFF configuration.

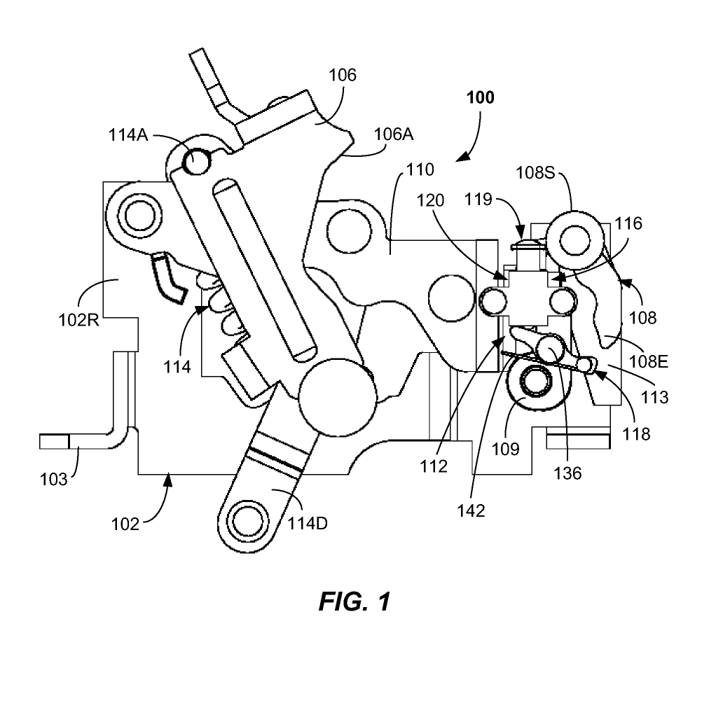

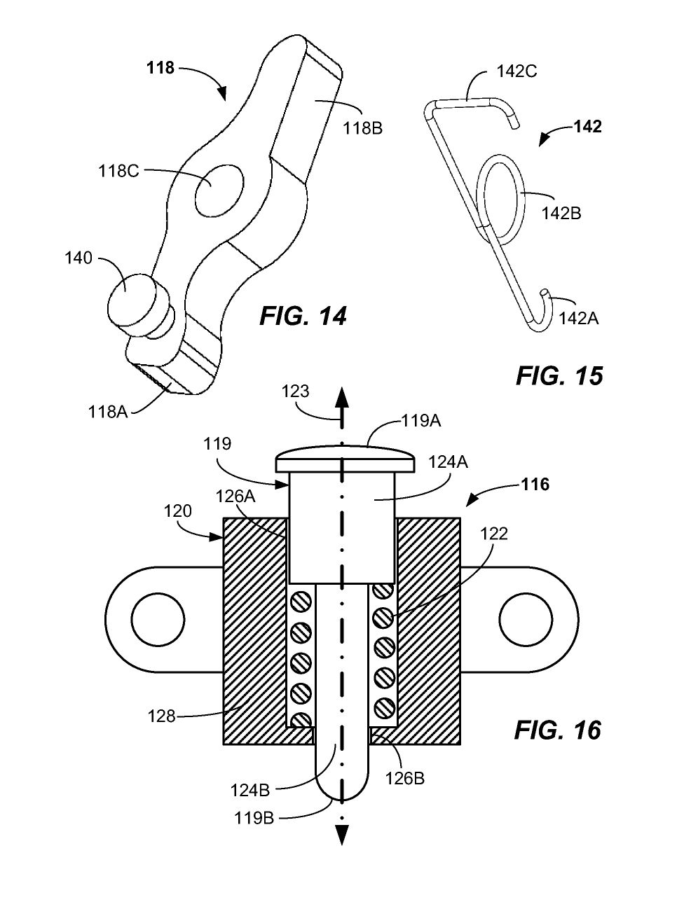

These and other embodiments of blocking subassemblies, no trip at OFF circuit breakers, and methods of the present invention are described below with reference to FIGS. 1-17. The drawings are not necessarily drawn to scale. Like numerals are used throughout the specification to denote like elements.

Referring now in specific detail to FIGS. 1-7B, a no trip at OFF circuit breaker 100 is shown. Various configurations of the circuit breaker 100 are shown to enable understanding of the operation of the no trip at OFF circuit breaker 100. The no trip at OFF circuit breaker 100 will be referred to herein as a “no trip at OFF circuit breaker,” or simply “circuit breaker.” The circuit breaker 100 includes features and functions to prevent tripping when the circuit breaker 100 is configured in the OFF configuration.

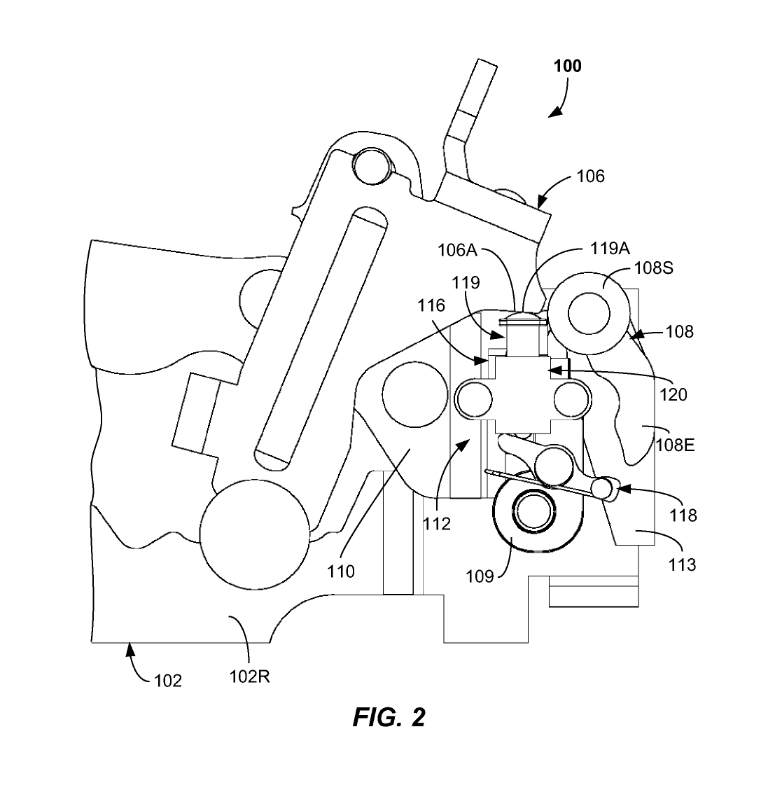

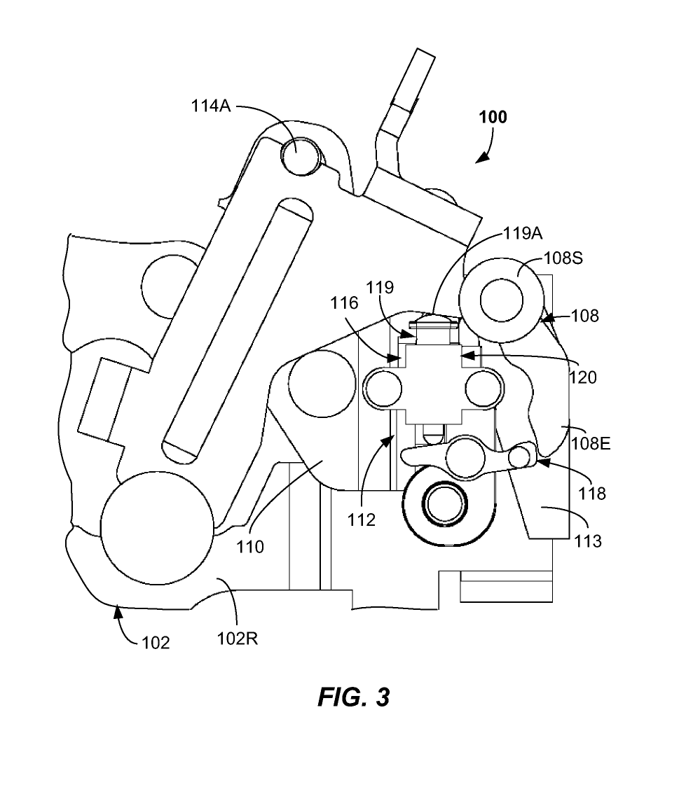

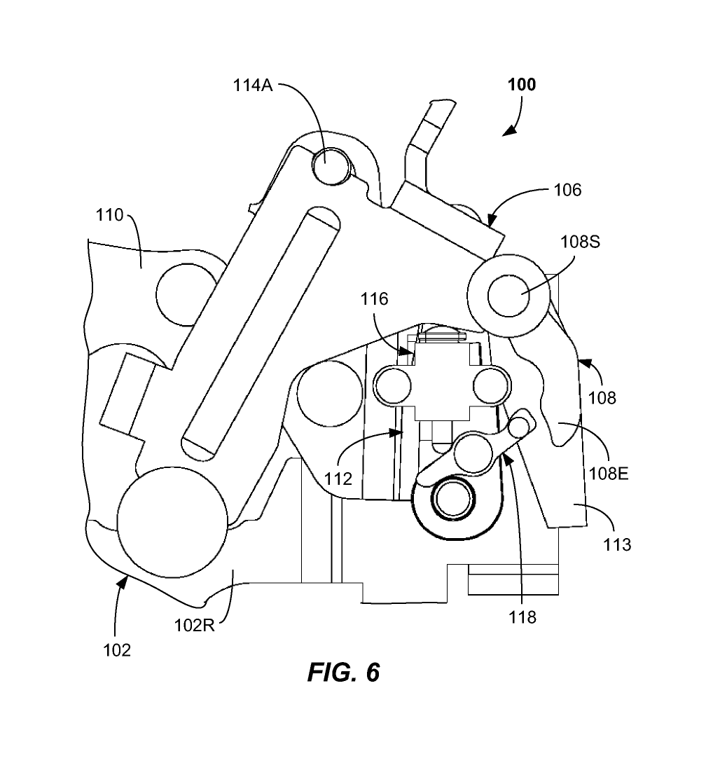

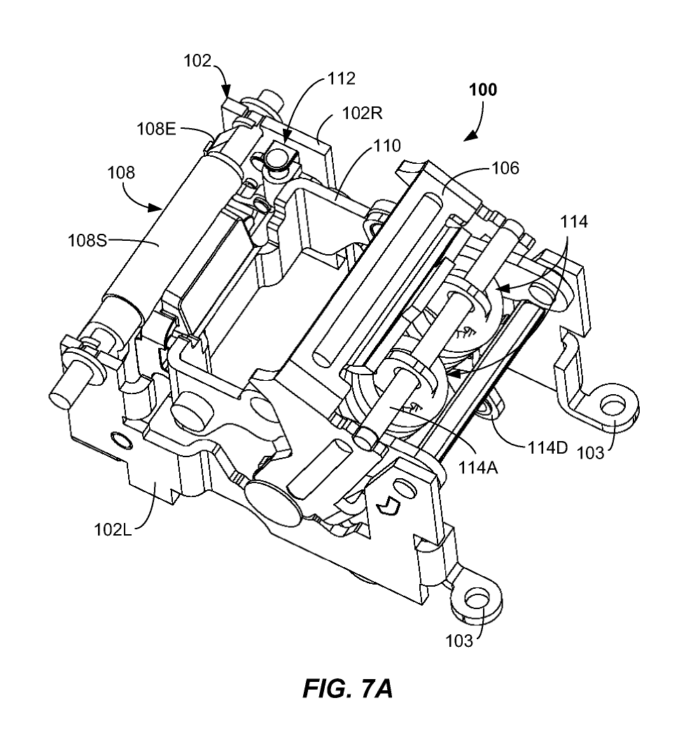

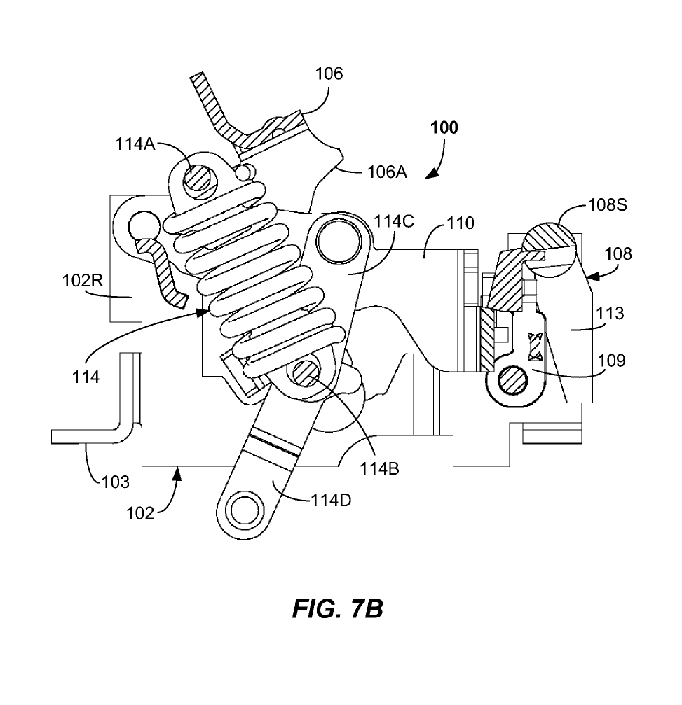

Referring to FIGS. 1-7B, the circuit breaker 100 includes a frame 102, which may be formed from several frame portions. According to some embodiments, the frame 102 may include a left frame 102L and right frame 102R, as best shown in FIG. 7A. In the depicted embodiment, left and right frames 102L, 102R may be mounted to a larger housing assembly (e.g., a thermosetting plastic housing—not shown) by inserting fasteners in mounting features 103. The fasteners may include screws, bolts, rivets, or the like. A handle arm 106 is provided and mounted for rotation relative to the frame 102. In particular, the handle arm 106 may extend between side frames 102L, 102R. Handle arm 106 may be of any conventional or suitable construction. Movement of the handle (not shown) coupled to the handle arm 106 causes the setting the circuit breaker 100 in the various configurations such as ON configuration (FIG. 1), the just prior to OFF configuration (FIG. 2), the OFF configuration (FIG. 3) and the RESET configuration (FIG. 6). The frame 102 may be made from any suitable rigid material, such as stamped steel. Other materials may be used. Furthermore, other numbers of frame portions and constructions may be used to form the frame 102.

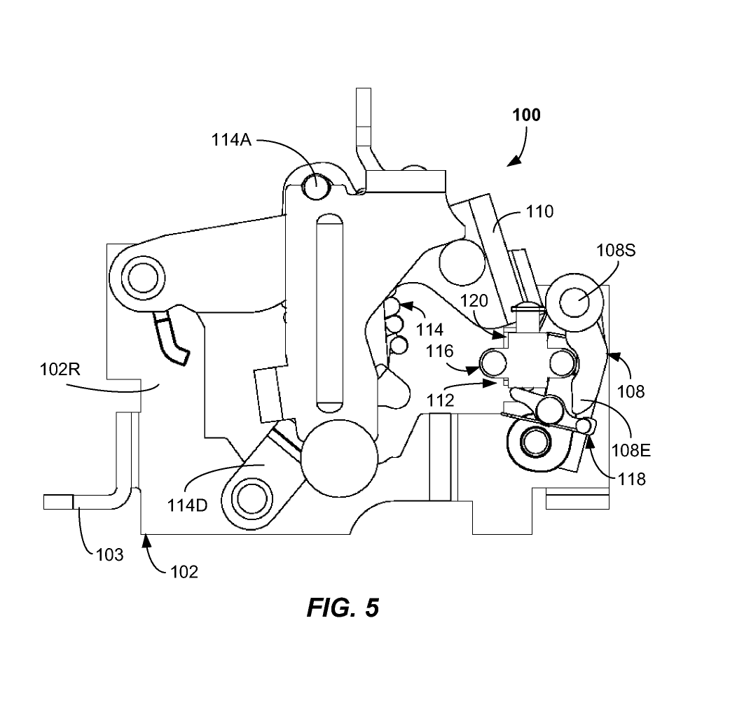

The circuit breaker 100 includes a trip bar 108 that functions to rotate and cause tripping of the circuit breaker 100 from the ON configuration (FIGS. 1 and 7B) to the TRIP configuration (FIG. 5) in response to a tripping event (i.e., any event that causes circuit breaker tripping). As illustrated in FIGS. 1-7B and FIG. 13, the trip bar 108 includes a shaft portion 108S extending between the left frame 102L and right frame 102R. The trip bar 108 may be mounted for rotation in the frame 102 at both ends. In the depicted embodiment, the trip bar 108 functions in operation to engage a latch 109 (FIG. 7B). Release of the latch 109 by the trip bar 108 causes a release of a cradle 110 and causes tripping of the circuit breaker 100 and separation of the main electrical contacts (not shown) thereby opening the protected electrical circuit. The trip bar 108 includes an extending portion 108E that is adapted to interface with a blocking assembly 112 described below herein. The trip bar 108 may also include a lever 113 that is adapted to be contacted by a maglatch actuator (e.g., a solenoid—not shown) when an electronic circuit (not shown) of the circuit breaker 100 senses a condition (e.g., an arc fault condition) that warrants tripping of the circuit breaker 100.

As shown in FIGS. 7A and 7B, other circuit breaker components are shown. The circuit breaker 100 may include other conventional components, such as one or more spring assemblies 114 connected between a spring shaft 114A extending between the sides of the handle arm 106 and a toggle shaft 114B coupled to a upper toggle link 114C and lower toggle link 114D.

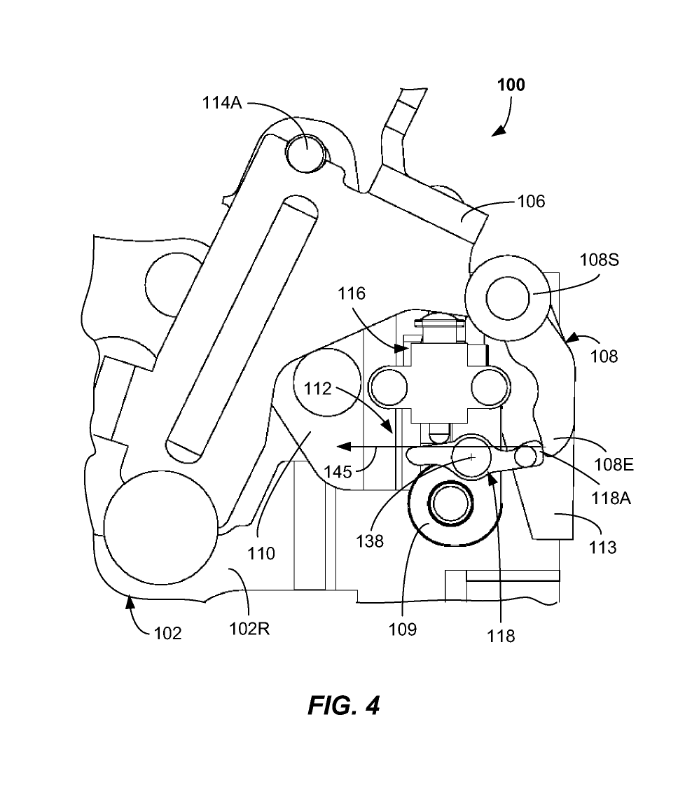

Again referring to FIG. 1, an illustrative left side view diagram of the circuit breaker 100 in accordance with embodiments of the present invention is shown with the left frame 102L being removed for clarity. The circuit breaker 100 may include conventional components such as the handle arm 106, latch 109 (FIG. 7A-7B), cradle 110, one or more spring assemblies 114 and also includes the inventive blocking subassembly 112 that is adapted to block tripping of the circuit breaker 100 when the circuit breaker is configured in the OFF configuration (see FIGS. 3 and 4).

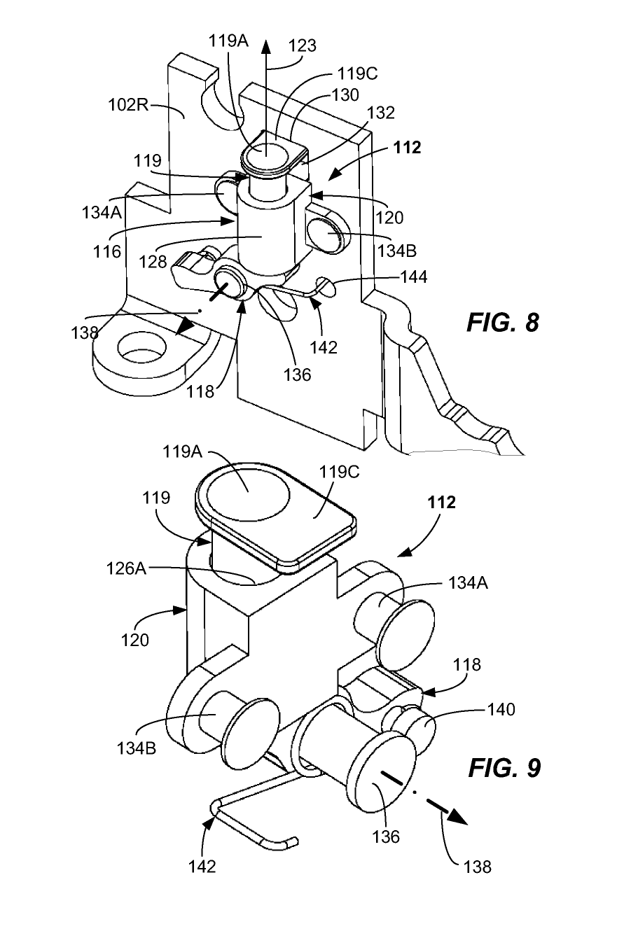

In more detail, the blocking subassembly 112 may be mounted at any convenient location within the circuit breaker 100. In the depicted embodiment, the components of the blocking subassembly 112, as best shown in enlarged views of FIG. 8 and FIG. 9, are mounted to the right frame 102R by rivets, screws, or other suitable fastening means. However, it should be understood that the blocking subassembly 112 may optionally be mounted to the left frame 102R or elsewhere on the frame 102 at a suitable location relative to the trip bar 108. In the depicted embodiment, the blocking subassembly 112 includes a plunger subassembly 116 that is adapted to cooperate with, and engage, the handle arm 106 and a trip bar block 118. As will be apparent, the blocking subassembly 112 functions and operates to block and retrain motion of the trip bar 108 when the circuit breaker 100 is in the OFF configuration.

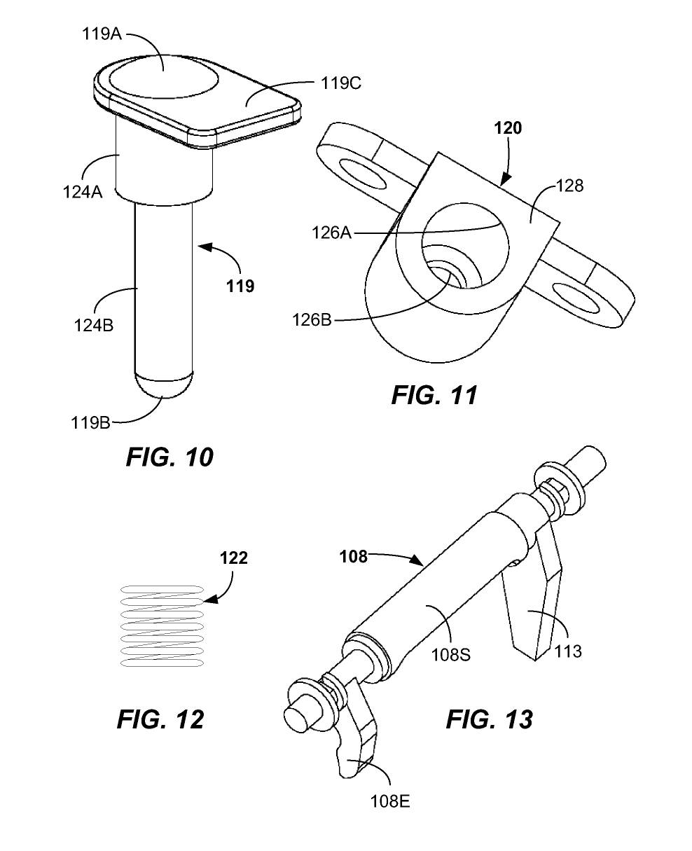

In more detail, the plunger subassembly 116 shown in FIGS. 8, 9 and 16 includes a plunger 119, a plunger holder 120, and a spring 122. The plunger 119, as best shown in FIGS. 10 and 16, may include one or more portions, such as cylindrical portions 124A, 124B shown, that are capable of moving (e.g., reciprocating) in one or more guides 126A, 126B formed in a body 128 of the plunger holder 120 (FIG. 11). The plunger 119, as shown in FIG. 10, may further include a first end 119A adapted to engage a portion 106A of the handle arm 106, and a second end 119B adapted to engage the trip bar block 118. The portion 106A of the handle arm 106 may be a flat surface of sufficient length formed on an underside of the handle arm 106. However, any portion of the handle arm 106 may be used to contact and engage the plunger 119, such as a tab or projection formed thereon. Each end 119A, 119B of the plunger 119 may include a non-planar contact surface adapted to engage with the portion 106A of the handle arm 106 and the trip bar block 118. For example, the ends 119A, 119B may include a domed or curved surface thereon.

The first end 119A of the plunger 119 may also include an extension 119C (e.g., a lateral projection or lip) configured to be received against a stop 130 (FIG. 8). The stop 130 may be a portion of a slot 132 formed in the side frame 102R, for example. Optionally, the stop 130 may comprise a bent tab or other motion-limiting geometrical feature. The stop 130 functions to limit the extension motion of the plunger 119 relative to the holder 120 and right frame 102R along axis 123. Rotation of the plunger 119 about axis 123 relative to the frame 102 may also be restrained by the extension 119C engaging with respective sides of the slot 132.

The spring 122 (FIGS. 12 and 16) is connected between respective shelves formed on the plunger 119 and the holder 120 to normally bias the plunger 119 along a primary axis 123 to a normally-extended configuration (show in FIGS. 8 and 16) when the circuit breaker 100 is not in the OFF configuration. The spring may be a coil spring as shown or any other suitable spring to cause such biasing. The holder 120 may be connected to a frame 102R of the circuit breaker 100 by fasteners 134A, 134B such as rivets, screws, or other fastening means. Optionally, the holder 120 and one or more guides 126A, 126B may be formed integrally with the side frame 102R.

In more detail, the trip bar block 118, as shown in FIGS. 8, 9 and 14, has a first portion 118A adapted to engage the extended portion 108E of the trip bar 108, and a second portion 118B adapted to engage the second end 119B of the plunger 119. In the depicted embodiment, the trip bar block 118 has a pivot portion 118C between the first portion 118A and the second portion 118B. The pivot portion 118C may be formed by a hole receiving a suitable pivot member 136. The trip bar block 118 may be pivotally mounted to the right frame 102R by any suitable pivot member 136, such as a stepped rivet, stepped screw, screw and sleeve, or other suitable pivot-forming component. Accordingly, the trip bar block 118 may pivot about a longitudinal axis 138 that may be generally perpendicular and normal to a surface of the right frame 102R.

The trip bar block 118 may also include a spring mounting tang 140 upon which a bias spring 142 may be mounted. The bias spring 142 shown in FIGS. 8, 9 and 15 may include a first part 142A that is received on the spring mounting tang 140, a second part 142B (e.g., a loop) that is received over the pivot member 136, and a third part 142C that is received through a hole 144 (FIG. 8) in the right frame 102R or otherwise restrained relative to the right frame 120R. The bias spring 142 functions to cause the trip bar block 118 to always be biased into engaging contact with the second end 119B of the plunger 119 regardless of whether the handle arm 106 is in the ON configuration, OFF configuration, or TRIP configuration. Other suitable bias spring constructions may be used.

The operation of the blocking subassembly 112 will now be described in more detail with reference to FIGS. 2-4. As the handle arm 106 is moved from the ON configuration (FIG. 1) to the just prior to OFF configuration (FIG. 2), the handle portion 106A of the handle arm 106 comes into engaging contact with the first end 119A of the plunger 119. Upon further motion of the handle arm 106 to the OFF configuration shown in FIG. 3, the plunger 119 translates within the one or more guides 126A, 126B of the plunger holder 120. This translation operates against the force of the spring 122 and therefore causes rotates the trip bar block 118 about the longitudinal axis 138 (FIGS. 8 and 9). This rotation brings the first portion 118A of the trip bar block 118 into alignment with the extension portion 108E of the trip bar 108 as shown in FIG. 3. In this configuration, the trip bar block 118 is readied to block further rotation from the non-contacting position shown in FIG. 3 should the circuit breaker 100 attempt to trip due to one of the causes mentioned above.

FIG. 4 illustrates the trip bar 108 actually being in the no trip at OFF configuration where the circuit breaker 100 has attempted to trip. In this instance, the trip bar 108 tries to rotate to trip the latch 109, but is prevented from doing so by the blocking subassembly 112, and particularly the hard contact made between the extending portion 108E of the trip bar 108 and the first end 118A of the rotated and aligned trip bar block 118. As shown in FIG. 4, the force vector 145 upon contact between the extending portion 108E of the trip bar 108 and the first end 118A of the rotated trip bar block 118 is designed to be slightly above the axis of rotation 138. This may enable stable blocking action of the trip bar 108 by the trip bar block 118.

FIG. 5 illustrates the circuit breaker 100 configured in a TRIP configuration after the circuit breaker 100 has been tripped from the ON configuration due to a tripping event. As should now be apparent, the blocking subassembly 112 is inoperative when the circuit breaker 100 is in the ON configuration (FIG. 1) and the TRIP configuration (FIG. 5). In these configurations, the trip bar block 118 is rotated so that no interference with the extending portion 108E of the trip bar 108 is made. The extending portion 108E may include a recessed portion along its length so that the extending portion 108E doesn't interfere with the plunger holder 120 in the TRIP configuration shown in FIG. 5.

FIG. 6 illustrates the circuit breaker 100 configured in a RESET configuration after the circuit breaker 100 has been tripped and is being reset from the TRIP configuration after a tripping event. As should be apparent, the trip bar block 118 is rotated further beyond the blocking orientation of FIG. 4 and then rotated back when the handle arm 106 is again rotated to the ON configuration.

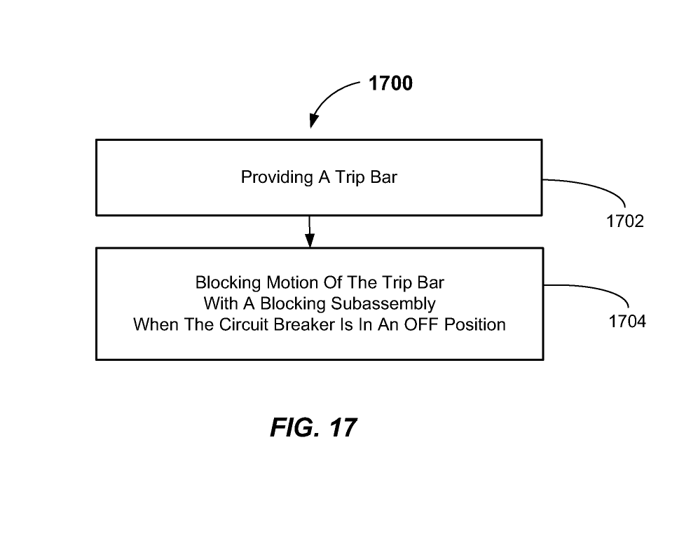

FIG. 17 is a flowchart illustrating a method of operating a circuit breaker 100 according to an aspect of the present invention. The method 1700 includes providing a trip bar (e.g., trip bar 108) in 1702, and then blocking a motion of the trip bar (e.g., trip bar 108) with a blocking subassembly (e.g., blocking subassembly 112) when the circuit breaker (e.g., circuit breaker 100) is in an OFF configuration.

While the invention is susceptible to various modifications and alternative forms, specific embodiments and methods thereof have been shown by way of example in the drawings and are described in detail herein. It should be understood, however, that it is not intended to limit the invention to the particular apparatus, systems, or methods disclosed, but, to the contrary, the intention is to cover all modifications, equivalents, and alternatives falling within the spirit and scope of the invention.

What is claimed is:

1. A circuit breaker, comprising:
a blocking subassembly adapted to block tripping of the circuit breaker in an OFF configuration.

2. The circuit breaker of claim 1, wherein the blocking subassembly operates to block motion of a trip bar when the circuit breaker is in the OFF configuration.

3. The circuit breaker of claim 1, wherein the blocking subassembly comprises a plunger subassembly and a trip bar block.

4. The circuit breaker of claim 1, wherein the blocking subassembly comprises a plunger subassembly including a plunger moveable in one or more guides.

5. The circuit breaker of claim 4, wherein the plunger subassembly comprises:
a holder including the one or more guides;
a spring connected between the plunger and the holder to bias the plunger to an extended configuration when the circuit breaker is not in the OFF configuration.

6. The circuit breaker of claim 4, wherein the plunger subassembly is connected to a frame of the circuit breaker.

7. The circuit breaker of claim 1, comprising:
a frame;
a handle arm moveable relative to the frame; and
a trip bar adapted to move in response to a tripping event.

8. The circuit breaker of claim 7, wherein the blocking subassembly includes:
a trip bar block;
a plunger moveable relative to the frame, the plunger including a first end adapted to engage the handle arm, and a second end adapted to engage the trip bar block;
one or more guides receiving the plunger; and
a spring connected to the plunger and adapted to bias the plunger to an extended configuration when not in the OFF configuration.

9. The circuit breaker of claim 1, wherein the blocking subassembly comprises a trip bar block.

10. The circuit breaker of claim 9, wherein the trip bar block comprises a first portion adapted to engage the trip bar, and a second portion adapted to engage an end of a plunger.

11. The circuit breaker of claim 10, wherein the trip bar block comprises a pivot portion between the first portion and the second portion.

12. A circuit breaker, comprising:
a trip bar adapted to rotate in response to a tripping event; and
a blocking subassembly adapted to block tripping of the trip bar when the circuit breaker is in an OFF configuration.

13. A circuit breaker, comprising:
a frame;
a handle arm moveable relative to the frame;
a trip bar adapted to rotate in response to a tripping event; and
a blocking subassembly adapted to block motion of the trip bar when the circuit breaker is in an OFF configuration, the blocking subassembly having
a plunger translatable relative to the frame in one or more guides, the plunger including a first end adapted to engage the handle arm and a second end, and
a rotatable trip bar block having a first portion and a second portion, the second portion adapted to engage the second end of the plunger, and the first portion adapted to contact the trip bar to prevent tripping in the OFF configuration.

14. A method of operating a circuit breaker, comprising:
providing a trip bar; and
blocking motion of the trip bar with a blocking subassembly when the circuit breaker is in an OFF configuration.

15. The method of claim 14, wherein the blocking motion comprises blocking rotation of the trip bar.

16. The method of claim 14, wherein the blocking motion comprises rotating a trip bar block into alignment with an extending portion of the trip bar when the circuit breaker is in the OFF configuration.

17. The method of claim 14, wherein the blocking motion comprises translating a plunger by contact with a portion of a handle arm.

18. The method of claim 14, wherein the blocking motion comprises:
translating a plunger with a portion of a handle arm; and
contacting a trip bar block with an end of the plunger thereby rotating the trip bar block into alignment with an extending portion of the trip bar when the circuit breaker is in the OFF configuration.

19. The method of claim 18, comprising contacting the extending portion of the trip bar with the trip bar block when the trip bar is tripped while in the OFF configuration.

20. The method of claim 14, comprising not blocking the trip bar with a blocking subassembly when the circuit breaker is in an ON configuration.
